(19) United States
(12) Patent Application Publication
(10) Pub. No.: US 2022/0382941 A1
(43) Pub. Date: Dec. 1, 2022

(54) METHOD FOR CALCULATING TIME HISTORY WIND LOAD IN ACCORDANCE WITH CORRELATION

(71) Applicant: Seoul National University R&DB Foundation, Seoul (KR)

(72) Inventors: Thomas Hyun Koo KANG, Seoul (KR); Seung Yong JEONG, Daejeon (KR)

(73) Assignee: Seoul National University R&DB Foundation, Seoul (KR)

(21) Appl. No.: 17/769,768

(22) PCT Filed: Aug. 18, 2021
(86) PCT No.: PCT/KR2021/010967

§ 371 Date: Apr. 18, 2022

(30) Foreign Application Priority Data
Aug. 19, 2020 (KR) 10-2020-0103923

(51) Int. Cl. G06F 30/28; G06F 30/13

(52) U.S. Cl. CPC G06F 30/28; G06F 30/13

(57) ABSTRACT

The present invention relates to a method for calculating a time history wind load in accordance with correlation, the method in which an artificial time history load close to reality can be generated without relying on a wind tunnel test, by applying the correlation between wind loads in two directions and adjusting the ratio of a maximum value of any one wind load relative to a maximum value of the other wind load.

### TECHNICAL FIELD

The present invention relates to a method of calculating a time history wind load considering correlation, which can generate an artificial time history load close to reality without ying on a wind tunnel test by reflecting correlation between wind loads in two directions and adjusting the ratio of a maximum value of any one wind load with respect to maximum values of the other wind loads.

### BACKGROUND ART

Time history analysis of wind loads is necessary in designing a building to consider wind loads that change over time. The time history generation method is largely divided into a method using autoregression analysis (Iwatani, 1996, Hwang Jong-guk et al., 1998) and a spectrum representation method (Hwang Jae-seung et al., 2015).

The loads including an along-wind load W₁ in the direction of blowing wind, an across-wind load W₂ in a direction perpendicular to the wind direction, and a torsional-wind load W₃ simultaneously act on a building in practice as shown in FIG. 1. Therefore, correlation between these various types of wind loads should be considered in generating a time history wind load.

Conventionally, when a time history wind load is generated using autoregression analysis, time history is generated considering intercorrelation between two time histories. However, as only a correlation according to a measurement position is considered for the same along-wind load, the accuracy is lowered for other types of wind directions.

Generation of a time history wind load according to the conventional spectrum representation method also does not consider correlation of the along-wind load, the across-wind load, and the torsional-wind load. This is since that when the purpose is a linear elastic design, it is possible to obtain a maximum response through analysis of each of the loads and overlap the maximum responses by applying a load combination factor.

The Korean Design Standard also presents a maximum value of each load in the form of an equivalent static load through frequency domain analysis using a power spectral density (PSD) function of the load in each direction in order to consider various types of wind loads in the design. Here, although a maximum value of a load is calculated in each direction, it is highly probable that maximum load values are not generated simultaneously in all directions in practice, a building is designed by applying a load combination factor to the maximum value of the load in each direction to compensate for this. At this point, in order to reflect the resonance effect of a structure in the process of calculating the equivalent static load, a first mode vibration shape is assumed, and influence of high-order modes is ignored.

Accordingly, accuracy of the equivalent static load decreases in a high-rise building where the effects of high-order modes increase. In addition, since influence of nonlinear P-A effect generated due to the gravity load is high in a high-rise building, linear overlapping is not allowed, and therefore, there is a limit in generating an accurate wind load. In addition, in the case of an inelastic structure, as overlapping is not allowed, all loads should be applied simultaneously, and a response should be obtained through nonlinear time history analysis.

In order to overcome the limitation of the design using an equivalent static load, there is a method of using a time history load measured through a wind tunnel test or regenerating an artificial time history load from a power spectral density function. However, the wind tunnel test is very expensive and time consuming. Therefore, a method of regenerating artificial time history loads using a power spectral density function established from results of wind tunnel tests performed in the past is also used for buildings of a formal shape.

When a one-sided power spectral density (PSD) function S(f) is given, time history load X(t) can be regenerated as shown in Equation 1.

[symbol]

X(t)=Σᵢⁿ\sqrt{2S(fᵢ)Δf} cos(2πfᵢt+θᵢ) [Equation 1]

Here, f denotes a frequency, Δf denotes a frequency step, and θi denotes a random phase angle between 0 and 2π.

[symbol]

At this point, the power spectral density function of each directional load is calculated through Fourier transform of an autocorrelation function, and information on the moment of maximum value is omitted for the load in each direction.

In addition, in the case of applying an independent phase angle θ when a load is regenerated in each direction, the correlation of wind loads in all directions is not reflected. Contrarily, when exactly the same phase angle θ is applied to the wind loads in all direction, there is a problem in that the correlation increases excessively, and the possibility of simultaneously generating maximum values of the loads in all directions increases excessively. In addition, it is difficult to predict a ratio of the maximum value of any one wind load at a moment when the maximum value is generated with respect to maximum values of the other wind loads, i.e., the maximum load ratio, using a coherence function that is frequently used as an index for evaluating the correlation by quantitatively indicating linear correlation between two random processes.

### DISCLOSURE OF INVENTION

### Technical Problem

Therefore, the present invention has been made in view of the above problems, and it is an object of the present invention to provide a method of calculating a time history wind load considering correlation, which can reflect correlation between wind. loads in two directions, and adjust the ratio of a maximum value of any one wind load with respect to maximum values of the other wind loads.

Another object of the present invention is to provide a method of calculating a time history wind load considering correlation, which can generate an time history load close to realitywithout relying on a wind tunnel test.

### Technical Solution

To accomplish the above objects, according to one aspect of the present invention, there is provided a method of calculating a time history wind load considering correlation, the method comprising the steps of: (a) setting any one among an along-wind load, an across-wind load, and a torsional-wind load as a first wind load, and setting any one among the remaining loads as a second wind load; (b) generating a first time history wind load for the first wind load using an arbitrary first random phase angle; and (c) generating a second time history wind load for the second wind load using a phase angle, which is the same as the first random phase angle of the first wind load, and a phase angle delay value.

According to another aspect of the present invention, there is provided a method of calculating a time history wind load considering correlation, in which the first time history wind load and the second time history wind load are calculated by the following [Equation 2] and [Equation 3], respectively.

A(t)=Σᵢⁿ\sqrt{2S_{A}(fᵢ)Δf} cos(2πfᵢt+θ_{Ai}) [Equation 2]

B(t)=Σᵢⁿ\sqrt{2S_{B}(fᵢ)Δf} cos(2πfᵢt+θ_{Ai}+cos⁻¹(k/∅)) [Equation 3]

Here, f denotes a frequency, Δf denotes a frequency step, θ_{Ai} denotes a random phase angle between 0 and 2π, S(f) denotes a power spectral density function with respect to frequency, k denotes a target maximum load ratio (or correlation factor of two time histories), cos⁻¹(k/∅) denotes a phase angle delay value, and ∅ denotes a similarity factor of the power spectral density function and is calculated as follows.

$$∅ = {Σ}_{i}^{n} \sqrt{\frac{{S}_{A} ( {f}_{i} ) Δ f}{{σ}_{A}^{2}} \cdot \frac{{S}_{B} ( {f}_{i} ) Δ f}{{σ}_{B}^{2}}}$$

σ_{A} and σ_{B} are standard deviations of time histories A(t) and B(t), respectively, and their squares are equal to the integral of power spectrum.

According to still another aspect of the present invention, there is provided a method of calculating a time history wind load considering correlation, in which the second time history wind load function adjusts the coherence of the first time history wind load function and the second time history wind load function according to a frequency by the combination of an arbitrary second random phase angle having a value independent from the first random phase angle.

According to still another aspect of the present invention, there is provided a method of calculating a time history wind load consdering correlation, in which the first time history wind load and the second time history wind load are calculated by the following [Equation 2] and [Equation 4], respectively.

A(t)=Σᵢⁿ\sqrt{2S_{A}(fᵢ)Δf} cos(2πfᵢt+θ_{Ai}) [Equation 2]

B(t)=Σᵢⁿ\sqrt{2S_{B}(fᵢ)Δf} cos(2πfᵢt+a(fᵢ)θ_{Ai}+b(fᵢ)−(a(fᵢ)+b(fᵢ)−1)π+cos⁻¹(k/∅)) [Equation 4]

Here, a( ) and b( ) are correlation functions having a value between 0 and 1 according to frequency, and satisfy \sqrt{a²+b²}=1.

According to still another aspect of the present invention, there is provided a method of calculating a time history wind load considering correlation, further comprising, after step (c), the step of (d) finally determining the first time history wind load and the second time history wind load using the random phase angle of step (b) when the difference between the maximum load ratio, which is calculated using the first time history wind load and the second time history wind load, and a target maximum load ratio is within an allowed error, and repeating steps (b) and (c) when the difference is out of the allowed error.

According to still another aspect of the present invention, there is provided a method of calculating a time history wind load considering correlation, further comprising, after step (d), the step of (e) applying a gradual loading filter that gradually increases and decreases magnitude of a response in an early part and a late part of time to the first time history wind load and the second time history wind load, respectively.

According to still another aspect of the present invention, there is provided a method of calculating a time history wind load considering correlation, in which at step (e), the first time history wind load and the second time history wind load are distributed in the vertical direction by a vertical distribution shape function.

### Advantageous Effects

According to the present invention, following effects can be expected.

First, it is possible to provide a method of calculating a time history wind load considering correlation, which can reflect the relation between wind loads in different directions by generating a time history wind load for each of a first wind load and a second wind load that are set among an along-wind load, an across-wind load, and a torsional-wind load.

Second, unlike the equivalent static load currently used in the conventional Korean Design Standard, a response of a structure can be more accurately calculated through time history analysis. Accordingly, it is possible to reflect the vibration mode of a structure more accurately and perform nonlinear analysis that cannot use the equivalent static load.

Third, as the ratio of a maximum value of any one wind load w th respect to maximum values of the other wind loads is adjusted using a power spectral density function and a coherence function that are established previously, an artificial time history load function close to reality can be generated without relying on a wind tunnel test.

Fourth, as the maximum load ratio between wind loads in different directions is adjusted, a time history wind load function may be generated to obtain a maximum load combination close to reality. Accordingly, over-design or under-design can be prevented.

### BRIEF DESCRIPTION OF THE DRAWINGS

FIG. 1 is a view showing a wind load acting on a building.

FIG. 2 is a flowchart illustrating a method of calculating a time history wind load considering correlation according to an embodiment of the present invention.

FIG. 3 is a graph showing adjustment of the maximum value ratio through phase angle shift.

FIGS. 4 to 6 are graphs showing the maximum load ratio according to a random phase angle.

FIGS. 7 and 8 are graphs showing a coherence function of one of time histories generated by reflecting phase angle delay.

FIG. 9 is a flowchart illustrating a method of calculating a time history wind load considering correlation according to another embodiment of the present invention.

FIG. 10 is a graph showing coherence of an across-wind load and a torsional-wind load according to an experiment.

FIG. 11 is a graph showing an embodiment of a correlation function.

FIG. 12 is a graph showing the maximum load ratio when phase angle delay is not reflected in the case of applying a correlation function.

FIG. 13 is a graph showing the maximum load ratio when phase angle delay is reflected in the case of applying a correlation function.

FIG. 14 is a flowchart illustrating a method of calculating a time history wind load considering correlation according to still another embodiment of the present invention.

FIG. 15 is a graph showing a gradual loading filter.

FIG. 16 is a graph showing an embodiment of a vertical distribution shape function.

FIG. 17 is a view showing graphs of time history wind loads generated by applying a gradual loading filter.

FIG. 18 is a view showing graphs of power spectral density functions of regenerated time history wind loads.

FIG. 19 is a view showing graphs of coherence of regenerated time history wind loads.

### BEST MODE FOR CARRYING OUT THE INVENTION

To accomplish the objects as described above, a method of calculating a time history wind load considering correlation according the present invention comprises the steps of: (a) setting any one among an along-wind load, an across-wind load, and a torsional-wind load as a first wind load, and setting any one among the remaining loads as a second wind load; (b) generating a first time history wind load for the first wind load using an arbitrary first random phase angle; and (c) generating a second time history wind load for the second wind load using a phase angle, which is the same as the first random phase angle of the first wind load, and a phase angle delay value.

Hereinafter, the present invention will be described in detail with reference to the accompanying drawings and preferred embodiments.

[symbol]

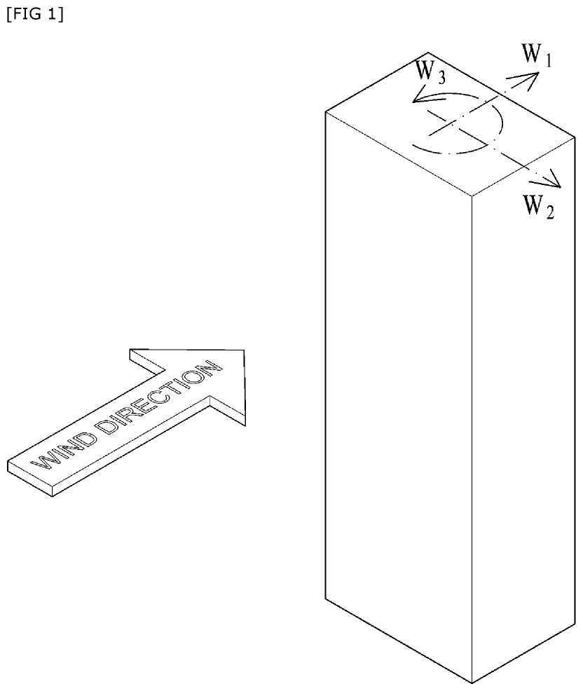

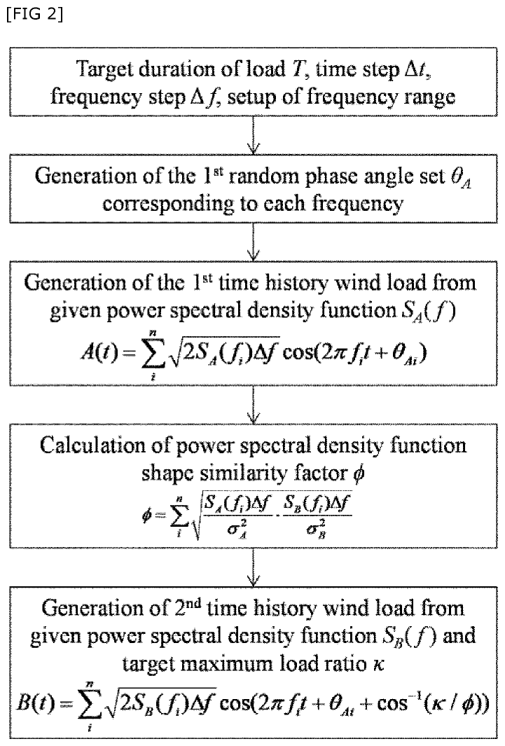

FIG. 1 is a view showing a wind load acting on a building, and FIG. 2 is a flowchart illustrating a method of calculating a time history wind load considering correlation according to an embodiment of the present invention.

As shown in FIG. 2, a method of calculating a time history wind load considering correlation according the present invention comprises the steps of: (a) setting any one among an along-wind load, an across-wind load, and a torsional-wind load as a first wind load, and setting any one among the remaining loads as a second wind load; (b) generating a first time history wind load for the first wind load using an arbitrary first random phase angle; and (c) generating a second time history wind load for the second wind load using a phase angle, which is the same as the first random phase angle of the first wind load, and a phase angle delay value.

An object of the present invention to provide a method of calculating a time history wind load considering correlation, which can generate an artificial time history load close to reality without relying on a wind tunnel test by reflecting correlation between wind loads in two directions and adjusting the ratio of a maximum value of any one wind load with respect to maximum values of the other wind loads.

The method calculating a time history wind load considering correlation according to the present invention first (a) sets any one among an along-wind load, an across-wind load, and a torsional-wind load as a first wind load, and sets any one among the remaining loads as a second wind load.

At step (a), in order to consider the relation between wind loads in two different directions, the load in one direction is set as a reference. The first wind load means a reference wind load, and the second wind load means a wind load in another direction combined with the first wind load.

For example, the across-wind load W₂ may be set as the first wind load, and the torsional-wind load W₃ may be set as the second wind load (FIG. 1).

[symbol]

Next, (b) a first time history wind load is generated for the first wind load using an arbitrary first random phase angle.

Since the first wind load is the reference wind load, the first time history wind load is generated by overlapping loads using the arbitrary first random phase angle.

[symbol]

Then, (c) a second time history wind load is generated for the second wind load using a phase angle, which is the same as the first random phase angle of the first wind load, and a phase angle delay value.

In order to reflect the correlation of the second wind load with respect to the first wind load, when the second time history wind load is generated for the second wind load, a value the same as the first random phase angle used when the first time history wind load is generated is used as the random phase angle.

However, in this case, there is a problem in that the correlation between the first wind load and the second wind load becomes excessive, and maximum values are generated almost simultaneously.

Therefore, when the second time history wind load is generated, the random phase angle is set to be the same as that of the first time history wind load, and the moments of generating the maximum values of the first time history wind load and the second time history wind load are adjusted by giving a phase angle delay value of a predetermined value. In this way, coherence of the two functions can be maintained.

As described above, in the present invention, unlike the equivalent static load currently used in the conventional Korean Design Standard, a response of a structure can be more accurately calculated through time history analysis. Accordingly, it is possible to reflect the vibration mode of a structure more accurately and perform nonlinear analysis that cannot use the equivalent static load.

In addition, the time history wind load function may be easily generated by using a power spectral density function and a coherence function previously established by researchers, without relying on a wind tunnel test every time.

In addition, the maximum response is the most important to design a building, and the present invention may generate a time history wind load function to obtain a maximum load combination close to reality by adjusting the maximum load ratio between wind loads in different directions. Accordingly, over-design or under-design can be prevented.

[symbol]

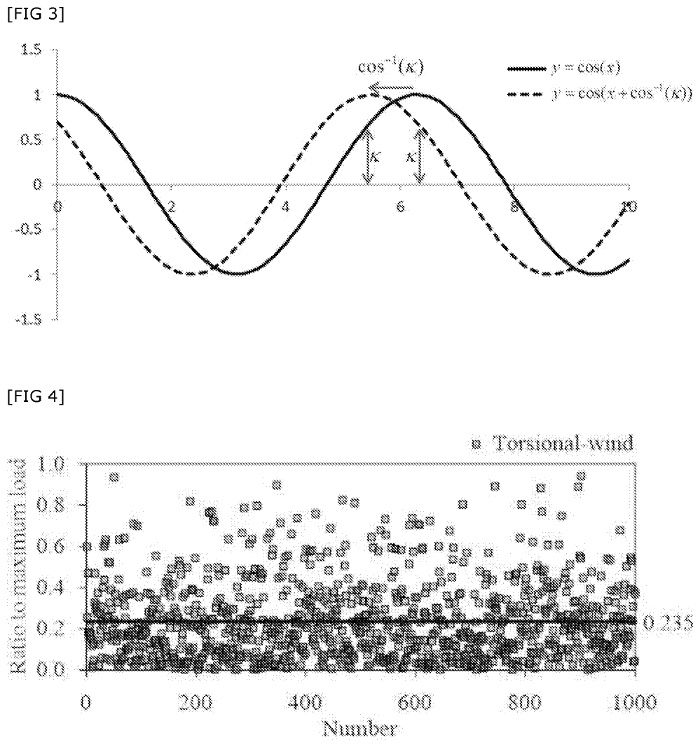

FIG. 3 is a graph showing adjustment of the maximum value ratio through phase angle shift.

The first time history wind load and the second time history wind load may be calculated by the following [Equation 2] and [Equation 3], respectively.

A(t)=Σᵢⁿ\sqrt{2S_{A}(fᵢ)Δf} cos(2πfᵢt+θ_{Ai}) [Equation 2]

B(t)=Σᵢⁿ\sqrt{2S_{B}(fᵢ)Δf} cos(2πfᵢt+θ_{Ai}+cos⁻¹(k/∅)) [Equation 3]

Here, f denotes a frequency, Af denotes a frequency step, θ_{Ai} denotes a random phase angle between 0 and 2π, S(f) denotes a power spectral density function with respect to frequency, k denotes a target maximum load ratio (or correlation factor of two time histories), cos⁻¹(k/∅) denotes a phase angle delay value, and ∅ denotes a similarity factor of the power spectral density function and is calculated as follows.

$$∅ = {Σ}_{i}^{n} \sqrt{\frac{{S}_{A} ( {f}_{i} ) Δ f}{{σ}_{A}^{2}} \cdot \frac{{S}_{B} ( {f}_{i} ) Δ f}{{σ}_{B}^{2}}}$$

Here, σ_{A} and σ_{B} are standard deviations of time histories A(t) and B(t), respectively, and their squares are equal to the integral of power spectrum.

[symbol]

To calculate the first time history wind load and the second time history wind load, as shown in FIG. 2, a target duration of load T, a time step Δt, a frequency step Δf, and a frequency range are set, and a first random phase angle θ corresponding to each frequency is generated.

Then, a first time history wind load function A(t) is generated from the given power spectral density function S(f), and a second time history wind load function B(t) is generated from the given power spectral density function S(f) and a phase angle delay value according to a target load ratio κ.

At this point, the amplitude of a cosine function corresponding to each i is determined by the power spectral density function, and the cycle is determined by 2πfᵢ, and the starting point is determined by the phase angle. Characteristics of irregular turbulence are reproduced by setting a random phase angle at each frequency and overlapping the time history wind loads.

The correlation between the two functions is maintained as the random phase angle of the second time history wind load function is set to be the same as the first random phase angle of the first time history wind load function. In addition, the moments of generating the maximum values of the first time history wind load and the second time history wind load are adjusted by adopting a phase angle delay value cos⁻¹(κ) (FIG. 3).

Here, the maximum load ratio is the ratio of B(t) to the maximum value of B(t) at the moment when A(t) is the maximum.

[symbol]

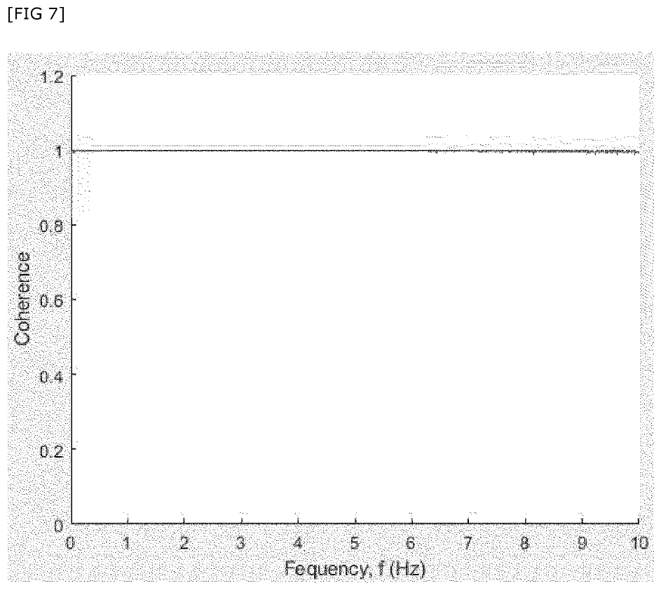

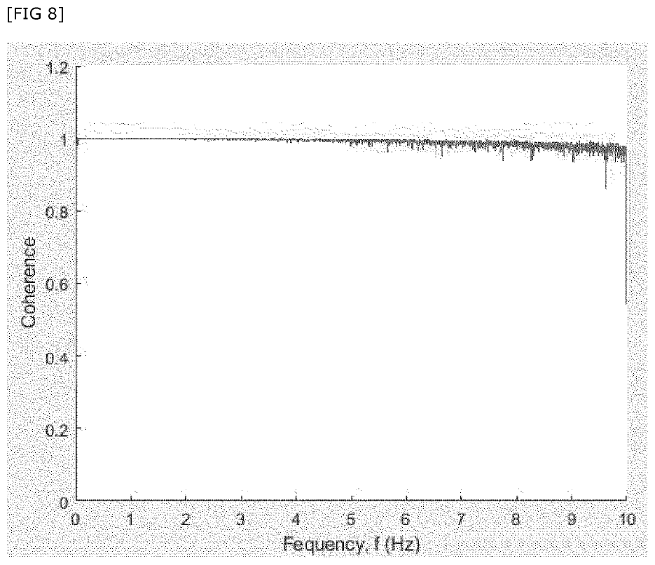

FIGS. 4 to 6 are graphs showing the maximum load ratio according to a random phase angle, and FIGS. 7 and 8 are graphs showing a coherence function of one of time histories generated by reflecting phase angle delay.

FIGS. 4 to 6 show results of generating 1,000 time history loads for the first time history wind load function and the second time history wind load function generated by setting the across-wind load as the first wind load and the torsional-wind load as the second wind load.

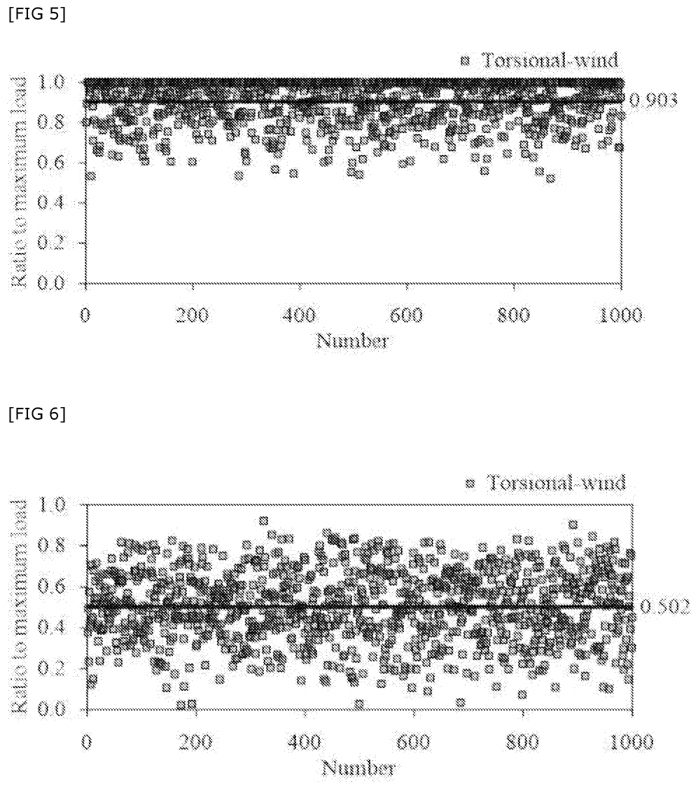

FIG. 4 is a view showing a result when independent random phase angles are used, FIG. 5 is a view showing a result when the same random phase angle is used, and FIG. 6 is a view showing a result when a phase angle delay value is reflected for the same random phase angle.

Specifically, when 1,000 time history loads are generated using completely independent random phase angles (θA, θB) in the first time history wind load function and the second time history wind load function when the across-wind load and the torsional-wind load are generated, it can be confirmed that there is no correlation as the maximum load ratio is 0.235 as shown in FIG. 4, which is extremely close to 0.2.

In addition, when the same random phase angle θ_{A} is used in the first time history wind load function and the second time history wind load function, it can be confirmed that the maximum load ratio reaches 0.903 as shown in FIG. 5 and the maximum values are generated almost simultaneously.

Contrarily, when exactly the same random phase angle is used in the first time history wind load function and the second time history wind load function, and the phase angle delay value with the target maximum load ratio κ set to 0.55 is reflected, it can be confirmed that the average maximum load ratio becomes 0.502 as shown in FIG. 6 to be close to the intended target maximum load ratio.

[symbol]

Meanwhile, FIGS. 7 and 8 are graphs showing a coherence function of one of time histories generated by reflecting phase angle delay.

FIG. 7 is a view showing a case in which the same first random phase angle is applied to the first time history wind load function and the second time history wind load function, and FIG. 8 is a view showing a coherence function when the phase angle delay according to the target maximum load ratio κ=0.55 is reflected.

In FIGS. 7 and 8, it can be confirmed that the coherence function is uniformly maintained although the phase angle delay is reflected.

[symbol]

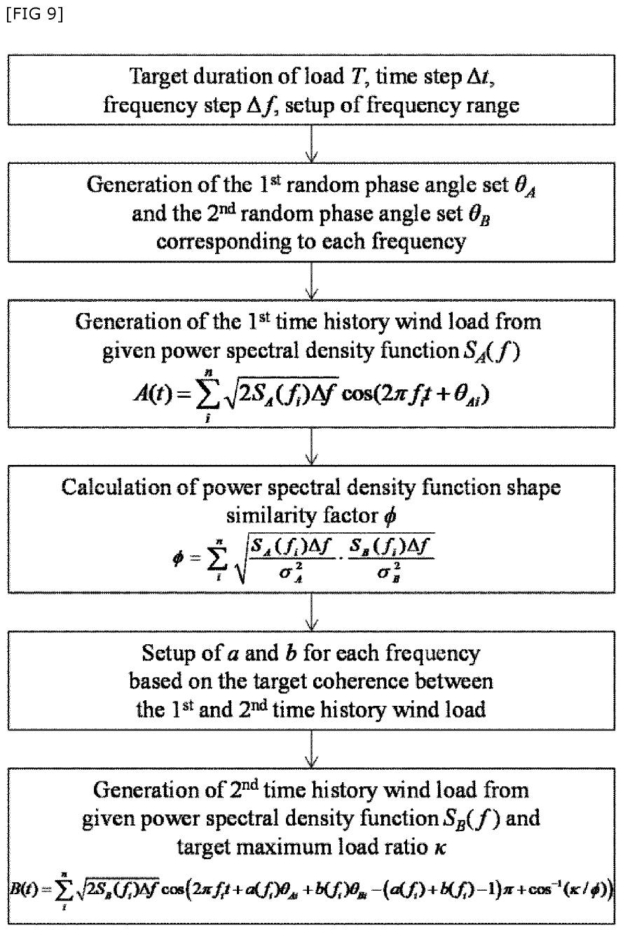

FIG. 9 is a flowchart illustrating a method of calculating a time history wind load considering correlation according to another embodiment of the present invention, and FIG. is a graph showing coherence of an across-wind load and a torsional-wind load according to an experiment.

As shown in FIG. 9, the second time history wind load function may be configured to adjust the coherence of the first time history wind load function and the second time history wind load function according to a frequency by the combination of an arbitrary second random phase angle having a value independent from the first random phase angle.

According to the Japanese building design standard AIJ 2015, although the correlation between the along-wind load and the across-wind load or the torsional-wind load is negligible, as the across-wind load and the torsional-wind load have a correlation, it is recommended to consider the correlation when the loads are combined.

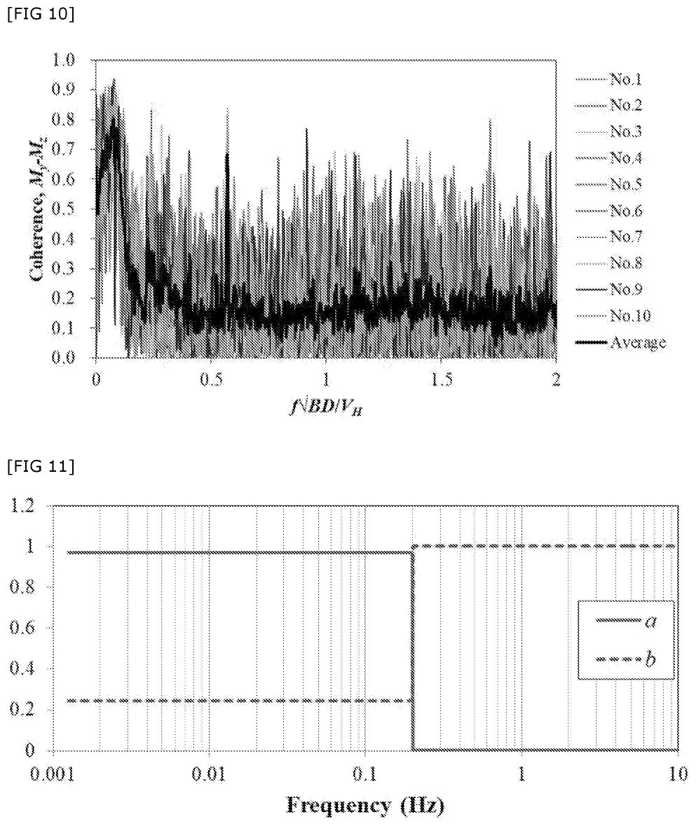

As a result of repeatedly measuring 10 times through a wind tunnel test on a building actually having a square plane and an aspect ratio of 3, it is shown that the along-wind load has a coherence of about 0.2 in all frequency domains with respect to the across-wind load and torsional-wind load. On the other hand, as shown in FIG. 10, it is confirmed that the coherence of the across-wind load and the torsional-wind load is particularly high in a low frequency domain.

This is due to the vortex shedding in the wake alternately occurring on both sides of a building in an elongated structure, and this is since the correlation appears large in a vortex shedding frequency domain.

However, when only the phase angle delay value is reflected, the coherence has a value almost close to 1 at any frequency regardless of the target maximum load ratio value, and there is a difference from an actual value. Therefore, it needs to adjust the coherence according to frequency when the second time history wind load function is regenerated.

To this end, a second random phase angle having a value completely independent from the first random phase angle used in the first time history wind load function is adopted, and it may be configured to adjust the coherence of the two functions at each frequency by adjusting contribution of each random phase angle by combining the first random phase angle and the second random phase angle according to the frequency in the second time history wind load function.

[symbol]

FIG. 11 is a graph showing an embodiment of a correlation function.

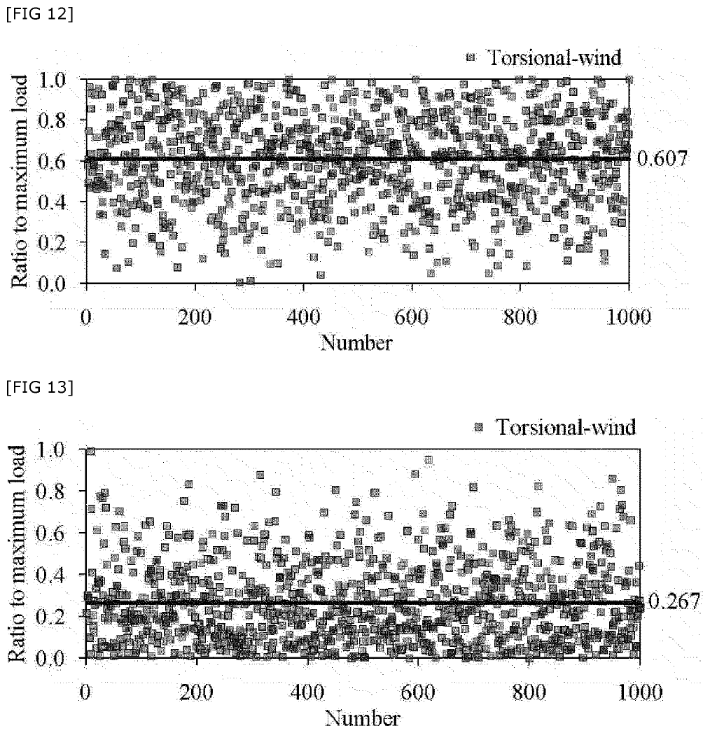

FIG. 12 is a graph showing the maximum load ratio when phase angle delay is not reflected in the case of applying a correlation function, and FIG. 13 is a graph showing the maximum load ratio when phase angle delay is reflected in the case of applying a correlation function.

As shown in FIG. 9, the first time history wind load may be calculated by Equation 2 shown above, and the second time history wind load may be calculated by the following [Equation 4].

B(t)=Σᵢⁿ\sqrt{2S_{B}(fᵢ)Δf} cos(2πfᵢt+a(fᵢ)θ_{Ai}+b(fᵢ)−(a(fᵢ)+b(fᵢ)−1)π+cos⁻¹(k/∅)) [Equation 4]

Here, a( ) and b( ) are correlation functions having a value between 0 and 1 according to frequency, and satisfy \sqrt{a²+b²}=1.

[symbol]

In order to adjust the coherence by combining a first random phase angle, which is equally used in two functions of the first time history wind load function and the second time history wind load function, and a second random phase angle completely independent from the first random phase angle by using a different weight value for each frequency, correlation functions a( ) and b( ) having a value between 0 and 1 according to frequency may be adopted in the first random phase angle and the second random phase angle respectively as shown in FIG. 11. In order to maintain the standard deviation of the combined phase angle generated as a result of combining the first random phase angle and the second random phase angle to be the same as the first and second random phase angles, a relation of \sqrt{a²+b²}=1 should be maintained. Since the average value of the combined phase angle may change as the values of the correlation functions a( ) and b( ) are selected, this is corrected using a term (a(fᵢ)+b(fᵢ)−1)π.

For example, in order to reflect the correlation between the actual across-wind load and torsional-wind load, the correlation may be increased by setting a( ) to be close to 1 and setting b( ) to be close to 0 in a low frequency domain. Alternatively, in a high frequency domain, the correlation may be lowered by contrarily setting a( ) to be small and setting b( ) to be large (FIG. 10).

The power spectral density function has a very large value in a vortex shedding frequency domain compared to those in other frequency domains. Accordingly, when a( ) has a value close to 1 in this domain, the moments of generating the maximum values of the first time history wind load function and the second time history wind load function are almost the same. Nevertheless, when a( ) and b( ) are set as shown in FIG. 11 considering coherence close to reality and the phase angle delay is not reflected, the moments of generating the maximum values are adjusted to a level similar to reality to some extent as shown in FIG. 12. However, additional correction may be required as the target maximum load ratio is not satisfied yet, and it is effective to adjust the maximum load ratio using the phase angle delay as needed. FIG. 13 is a view showing a case in which the correlation function of FIG. 11 is applied, and the target maximum load ratio κ is set to 0.3, and it can be confirmed that the maximum load ratio is almost the same as the target maximum load ratio.

[symbol]

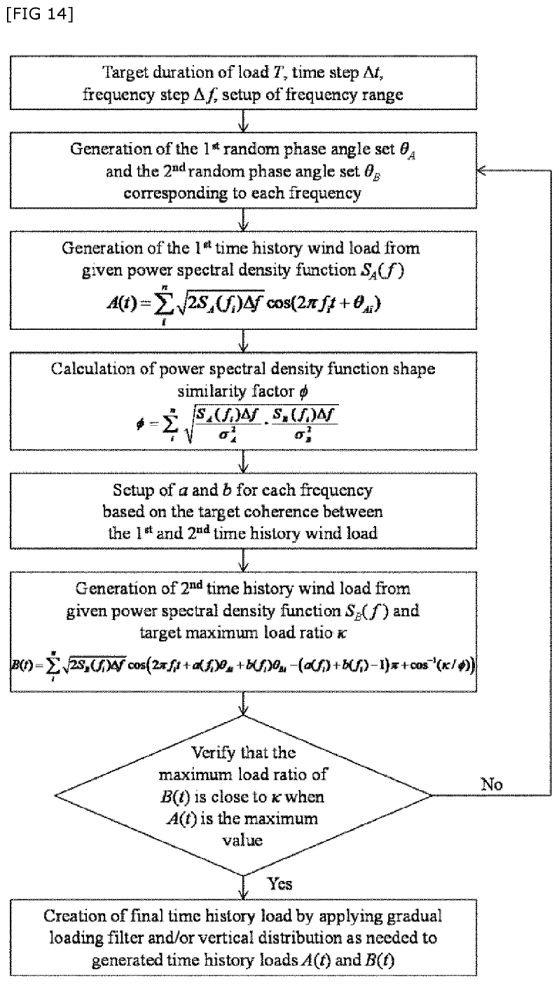

FIG. 14 is a flowchart illustrating a method of calculating a time history wind load considering correlation according to still another embodiment of the present invention.

As shown in FIG. 14, the method of calculating a time history wind load may further include, after step (c), the step of (d) finally determining the first time history wind load and the second time history wind load using the random phase angle of step (b) when the difference between the maximum load ratio, which is calculated using the first time history wind load and the second time history wind load, and a target maximum load ratio is within an allowed error, and repeating steps (b) and (c) when the difference is out of the allowed error.

The time history function is a probability function based on an arbitrary random phase angle, and the maximum load ratio calculated according to the value of the random phase angle may be significantly different from an intended target maximum load ratio. For example, although the target maximum load ratio κ is set to a value of 0.3, a result of simultaneously generating maximum values of the two functions may occur according to the value of the random phase angle.

Therefore, the maximum load ratio close to the intended ratio should calculated by excluding random phase angles that are not close to the target load ratio.

To this end, when the difference between the calculated maximum load ratio and the target maximum load ratio κ is out of the allowed error, the procedure of generating the first time history wind load function and the second time history wind load function is repeatedly performed by regenerating the first random phase angle and the second random phase angle corresponding to each frequency.

[symbol]

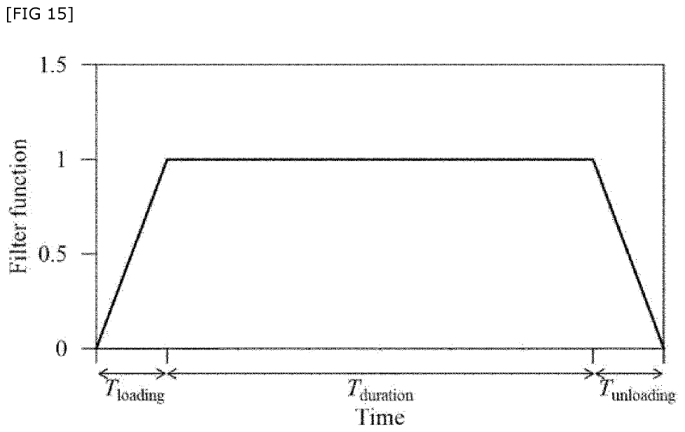

FIG. 15 is a graph showing a gradual loading filter.

The method of calculating a time history wind load may further include, after step (d), the step of (e) applying a gradual loading filter, which gradually increases and decreases magnitude of a response in an early part and a late part of time, to the first time history wind load and the second time history wind load, respectively.

Since the first time history wind load function and the second time history wind load function are probability functions, a large value of the generated load may act from the beginning (t=0). However, when this is used for analysis as it is, an excessive response may occur due to abrupt loading, and an aspect different from reality may occur.

In the linear analysis, only the response that comes after the excessive response at the beginning disappears due to attenuation can be utilized in consideration of weekly stationarity. However, in the nonlinear analysis, since the excessive response at the beginning affects the subsequent responses, gradual loading should be applied.

In addition, since it needs to review the residual permanent deformation in an inelastic behavior after the loading is completed, the load needs to be gradually reduced in the latter section.

Accordingly, a gradual loading filter may be used as shown in FIG. 15.

At this point, the gradual loading time is set to be much longer than the first mode period of the structure so that a resonance effect according to the gradual loading may not be generated.

[symbol]

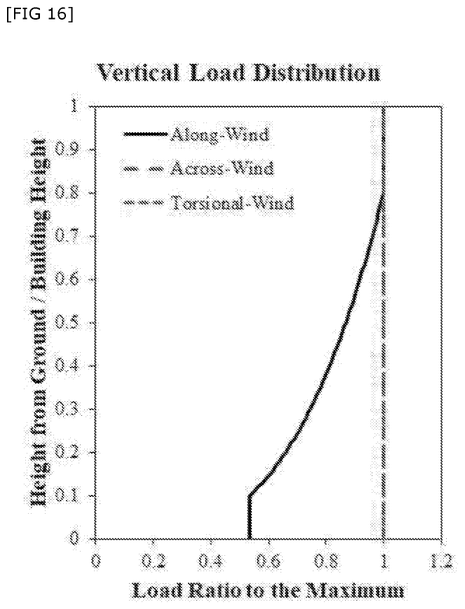

FIG. 16 is a graph showing an embodiment of a vertical distribution shape function.

At step (e), the first time history wind load and the second time history wind load may be distributed in the vertical direction by a vertical distribution shape function.

A power spectral density function is generally given to the across-wind load and the torsional-wind load in the form of a bottom overturning moment and a bottom torsional moment.

Therefore, since the regenerated time history load is also a bottom overturning moment and a bottom torsional moment, the regenerated time history load needs to be distributed as story loads for an analysis purpose.

To this end, the load may be distributed in the vertical direction by applying a vertical distribution shape function to each load.

[symbol]

In the Korean Design Standard, the along-wind load presents a load distribution in consideration of vertical distribution of wind pressure that actually acts on a building. However, since resonant components are dominant in the across-wind load and torsional-wind load, a linearly increasing load distribution is presented assuming a linear mode shape.

However, this is effective only for an equivalent static load that includes resonance components, and may not be applied to a time history load that does not include resonance components.

Therefore, as shown in FIG. 16, the along-wind load distributes loads in consideration of vertical distribution of wind pressure actually acting on a building, and it is reasonable to apply a uniform distribution shape to non-resonant components of the across-wind wind load and torsional-wind load.

[symbol]

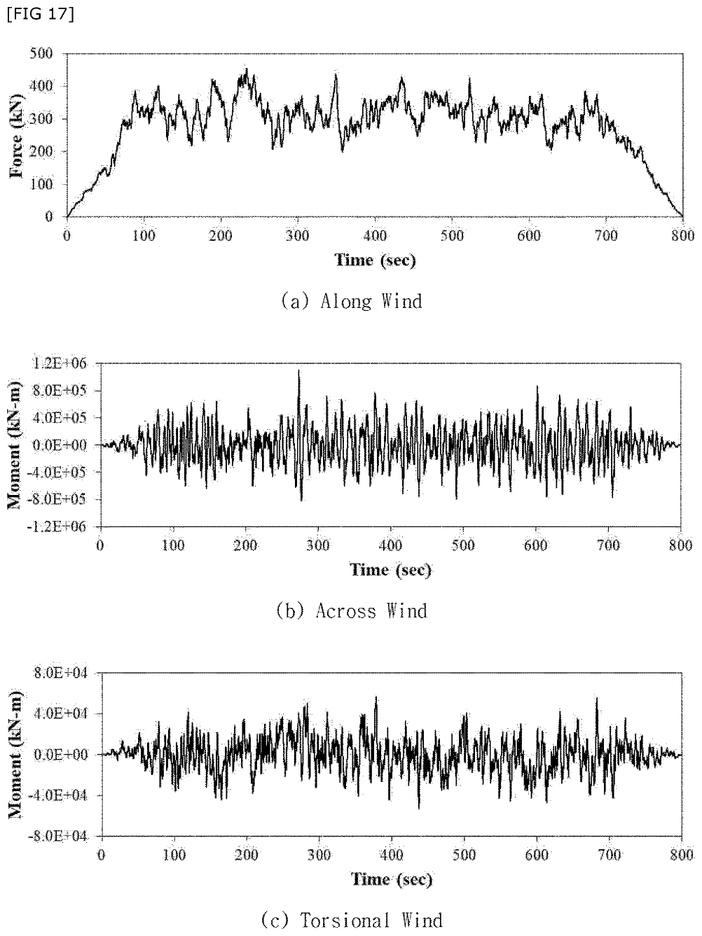

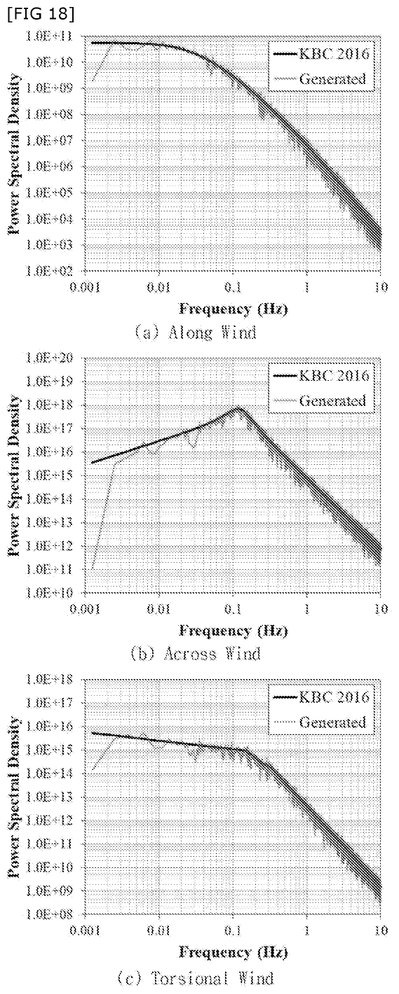

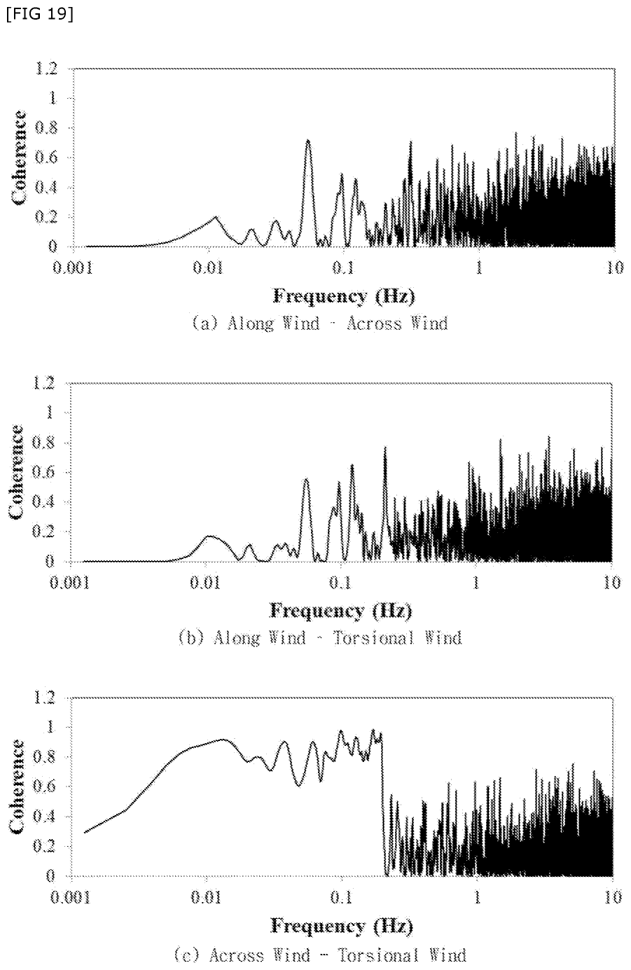

FIG. 17 is a view showing graphs of time history wind loads generated by applying a gradual loading filter, FIG. 18 is a view showing graphs of power spectral density functions of regenerated time history wind loads, and FIG. 19 is a view showing graphs of coherence of regenerated time history wind loads.

When the wind speed is 38 m/s, surface roughness classification is B, topographic factor is 1, and importance factor is 1, a time history wind load of a high-rise building having a width B of 36 m, a depth D of 36 m, and a height H of 180 m is generated according to the procedure of FIG. 14 using the time history wind load calculation method of the present invention.

In the gradual loading filter, T_{loading} and T_{unloading} are applied for 100 seconds each, T_{duration} is applied for 600 seconds, and the function of FIG. 11 is used as the correlation function. In addition, the target maximum load ratio of the across-wind load to the torsional-wind load is κ=0.3.

A result of generating a time history wind load according thereto is shown in FIG. 17.

In addition, FIG. 18 is a view showing comparison of the power spectral density function used for generating a time history load with the power spectral density function of a time history function regenerated by applying a gradual loading filter. It can be confirmed that the two values are very close.

In addition, FIG. 19 is a view showing coherence between regenerated time history functions. When the load in each direction is the maximum, the maximum load ratio is as shown below in [Table 1].

[symbol]

TABLE 1
Maximum load ratio of regenerated time history function

| Moment of maximum | | | Moment of maximum | | | Moment of maximum | | |
|---|---|---|---|---|---|---|---|---|
| along-wind load | | | across-wind load | | | torsional-wind load | | |
| Along- | Across- | Torsional- | Along- | Across- | Torsional- | Along- | Across- | Torsional- |
| wind | wind | wind | wind | wind | wind | wind | wind | wind |
| 1 | 0.1000 | 0.5281 | 0.8522 | 1 | 0.4078 | 0.7086 | 0.2894 | 1 |

[symbol]

### INDUSTRIAL APPLICABILITY

The method of calculating time history wind load considering correlation according the present invention is applicable in industry in that as the method may calculate a response of a structure more accurately through time history analysis, the vibration mode of a structure can be reflected more accurately, and nonlinear analysis that may not use the equivalent static load can be conducted.

1. A method of calculating a time history wind load considering correlation, the method comprising the steps of:
(a) setting any one among an along-wind load, an across-wind load, and a torsional-wind load as a first wind load, and setting any one among the remaining loads as a second wind load;
(b) generating a first time history wind load for the first wind load using an arbitrary first random phase angle; and
(c) generating a second time history wind load for the second wind load using a phase angle, which is the same as the first random phase angle of the first wind load, and a phase angle delay value.

2. The method according to claim 1, wherein the first time history wind load and the second time history wind load are calculated by the following [Equation 2] and [Equation 3], respectively,
$$A ( t ) = {\sum }_{i}^{n} \sqrt{2 {S}_{A} ( {f}_{i} ) Δ f} cos ( 2 π {f}_{i} t + {θ}_{A i} ) \qquad [ Equation 2 ]$$
$$B ( t ) = {\sum }_{i}^{n} \sqrt{2 {S}_{B} ( {f}_{i} ) Δ f} cos ( 2 π {f}_{i} t + {θ}_{A i} + {cos}^{- 1} ( k / ∅ ) ) , \qquad [ Equation 3 ]$$
wherein
f denotes a frequency, Af denotes a frequency step, θ_{Ai} denotes a random phase angle between 0 and 2π, S (f) denotes a power spectral density function with respect to frequency, k denotes a target maximum load ratio (or correlation factor of two time histories), cos⁻¹(k/∅) denotes a phase angle delay value, and ∅ denotes a similarity factor of the power spectral density function and is calculated as follows
$$∅ = {Σ}_{i}^{n} \sqrt{\frac{{S}_{A} ( {f}_{i} ) Δ f}{{σ}_{A}^{2}} \cdot \frac{{S}_{B} ( {f}_{i} ) Δ f}{{σ}_{B}^{2}}} ,$$
and
σ_{A} and σ_{B} are standard deviations of time histories A(t) and B(t), respectively, and their squares are equal to the integral of power spectrum.

3. The method according to claim 1, wherein a second time history wind load function adjusts coherence of a first time history wind load function and the second time history wind load function according to a frequency by combination of an arbitrary second random phase angle having a value independent from the first random phase angle.

4. The method according to claim 3, wherein the first time history wind load and the second time history wind load are calculated by the following [Equation 2] and [Equation 4], respectively,
$$A ( t ) = {\sum }_{i}^{n} \sqrt{2 {S}_{A} ( {f}_{i} ) Δ f} cos ( 2 π {f}_{i} t + {θ}_{A i} ) \qquad [ Equation 2 ]$$
$$B ( t ) = {\sum }_{i}^{n} \sqrt{2 {S}_{B} ( {f}_{i} ) Δ f} cos ( 2 π {f}_{i} t + a ( {f}_{i} ) {θ}_{A i} + b ( {f}_{i} ) - ( a ( {f}_{i} ) + b ( {f}_{i} ) - 1 ) π + {cos}^{- 1} ( k / ∅ ) ) , \qquad [ Equation 4 ]$$
wherein
a( ) and b( ) are correlation functions having a value between 0 and 1 according to frequency, and satisfy \sqrt{a²+b²}=1.

5. The method according to claim 2, further comprising, after step (c), the step of (d) finally determining the first time history wind load and the second time history wind load using the random phase angle of step (b) when a difference between a maximum load ratio, which is calculated using the first time history wind load and the second time history wind load, and a target maximum load ratio is within an allowed error, and repeating steps (b) and (c) when the difference is out of the allowed error.

6. The method according to claim 5, further comprising, after step (d), the step of (e) applying a gradual loading filter, which gradually increases and decreases magnitude of a response in an early part and a late part of time, to the first time history wind load and the second time history wind load, respectively.

7. The method according to claim 6, wherein at step (e), the first time history wind load and the second time history wind load are distributed in a vertical direction by a vertical distribution shape function.
